(19) United States
(12) Patent Application Publication
(10) Pub. No.: US 2004/0114757 A1
(43) Pub. Date: Jun. 17, 2004

(54) Method for generating an electronic key from a prime number contained in a specific interval and device therefor

(76) Inventors: Marc Joye, Saint Zacharie (FR); Pascal Paillier, Paris (FR)

Correspondence Address: BURNS DOANE SWECKER & MATHIS L L P, POST OFFICE BOX 1404, ALEXANDRIA, VA, 22313-1404, US

(21) Appl. No.: 10/311,153

(22) PCT Filed: Jun. 21, 2001
(86) PCT No.: PCT/FR01/04948

(30) Foreign Application Priority Data
Jul. 10, 2000 (FR) 00 08994

(51) Int. Cl. H04L 9/00

(52) U.S. Cl. 380/44

(57) ABSTRACT

A method for generating an electronic key from a prime number q contained in a specific interval of positive integers (wₘ, w_{M}). The method includes the following operations: a) selecting a positive integer η, where η is the product of the first k prime numbers, with k as maximum so that there exist two positive integers εₘ and ε_{M} such that εₘ is the higher round off of wₘ/η, and ε_{M} is the lower round off of (w_{M}−wₘ)/η, calculating II=εₘ η, generating two positive integers a and c belonging to the multiplicative group Z*_{II} of integers modulo II, with c prime with II, calculating q=c+ρ; b) testing the primality nature of q; c) if primality is verified, storing q; d) otherwise, updating c by calculating a.c mod II, and repeating the preceding operations from b) with the new value q=c+ρ. The invention is applicable to cryptography.

The invention relates to a method of generating an electronic key from a prime number q comprised in a given interval [wₘ, w_{M}] of positive integers. The invention likewise relates to a device for implementing the method.

The invention is particularly applied to protocols for public key cryptography used for encrypting information and/or for authentication between two entities and/or the electronic signature of messages.

It is particularly applied to protocols of public key cryptography such as the RSA (Rivest, Shamir and Adelman), El Gamal, Schnorr, or Fiat Shamir protocols.

In the case of such applications, use is made of the generation of large prime numbers (capable of being, for example, greater than or equal to 512 bits) to form one or more keys of the protocol.

A first method, termed “naïve,” for the generation of a prime number consists of:

choosing a candidate among odd numbers,

testing whether it is a prime,

if it is a prime, storing the number; if not, incrementing it by 2, the candidate is updated, the test is repeated with this new candidate, and so on until a candidate is found to be a prime.

This method is very slow. Another method consists of choosing the candidates for testing for primality among the numbers mutually prime with a prime number II. It will be recalled that two numbers are mutually prime, or co-prime, if and only if their greatest common divisor (gcd) is equal to 1. This other method consists of:

considering the number II=2. 3. 5. 7 . . . which is the product of the first k prime numbers (often k=4) and choosing a number p such that p is prime with II,

testing the primality of p,

if the primality of p is verified, this number is stored; if not, it is updated, incrementing it by II. This new candidate p is likewise co-prime with II; in fact, it will be recalled that

gcd (ρ+II, II)=gcd (ρ, II)=1.

the test is reiterated with this new candidate and so on, until a candidate is found which is a prime number.

This method is more efficient.

But in general it is desired to generate a prime number in a determined interval. In fact, in the case of the RSA public key cryptographic protocol, for example, the 1024-bit product of two numbers p and q is considered, that is, 2⁵¹¹.√2<p, q<2⁵¹². According to another protocol based on the discrete logarithm, obtaining a prime number of 1024 bits, that is, 2¹⁰²³<p≦2¹⁰²⁴ is directly sought. These protocols are found to be difficult to program (because complex) on portable devices of the microprocessor card type having a mediocre performance for the usual numbers of large size, 512 bits, 1024 bits or more.

The invention has as its object, given the interval [wₘ, w_{M}], to determine II once and for all and to propose an update of the candidate guaranteeing that the new candidate will be prime with II in the initially determined interval, while keeping the calculation time of these new candidates within reasonable limits, that is, while limiting the number of tests of primality.

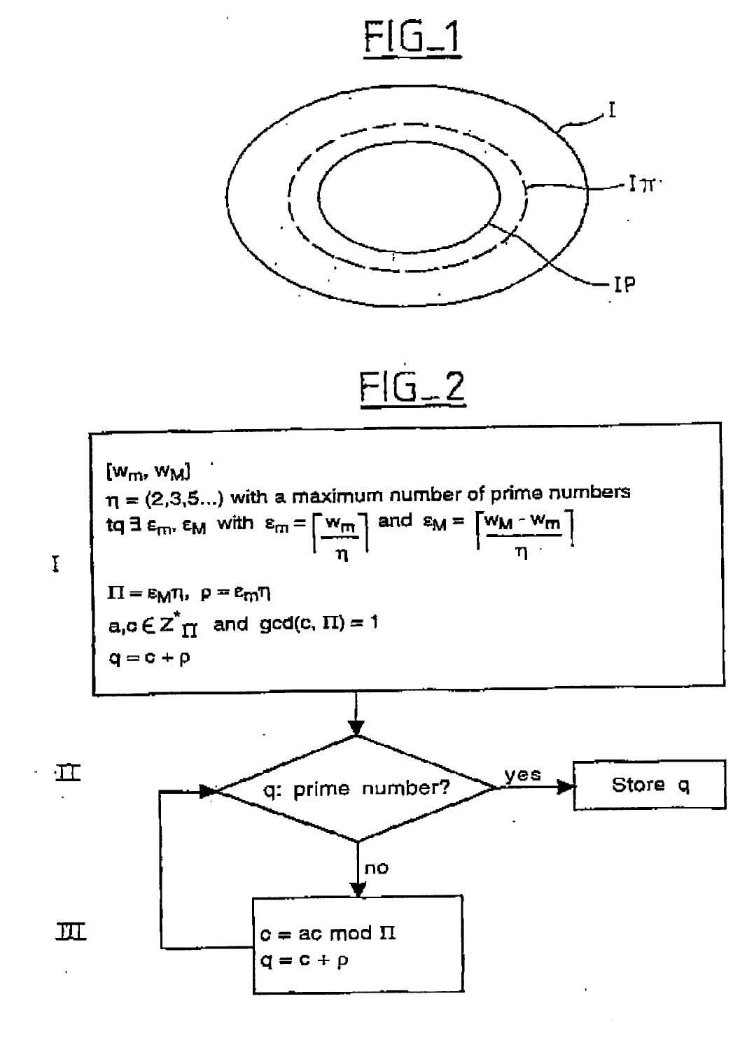

The choice of II is illustrated by FIG. 1, where there is represented the set I of integers comprised within an interval [wₘ, w_{M}], in which is included the set III if integers of this interval which are prime with II, in which set is included the set IP of prime numbers of this interval. The object consists of determining II such that the intermediate set III of the integers co-prime with II, that is, the set of candidates, is as close as possible to the subset IP of prime numbers in the interval.

The invention more particularly has as its object a method of generation of an electronic key starting from a prime number q comprised in a given interval [wₘ, w_{M}] of positive integers, principally characterized in that the prime number q is obtained by performing the following operations:

(a) choice of a positive integer η, η being the product of the first k prime numbers, with k the maximum for the existence of two positive integers εₘ and ε_{M} such that εₘ is the upper round number of wₘ/η, and ε_{M} is the lower round number of (w_{M}−wₘ)/η,

calculation of II=ε_{M}.η and ρ=εₘ.η,

generation of two positive integers a and c belonging to the multiplicative group Z*_{II} of integers modulo II, with c co-prime with II,

Calculation of q=c+p,

(b) test of the primality of q,

(c) in the case where primality is verified, q is stored,

(d) in the contrary case:

c is updated, calculating a.c mod II,

the preceding operations are reiterated, starting from (b), with the new value q=c+p.

According to a characteristic of the invention, a=2 and II=(ε_{M}−1).η.

According to another characteristic, a=2¹⁶+1.

The invention is applied to processes of generation of RSA, El Gamal, Schnorr, or Fiat Shamir cryptographic keys.

The invention likewise has as its object a portable electronic device comprising an arithmetic processor and an associated program memory, capable of performing modular calculations, principally characterized in that it comprises a primality verification program for a positive integer q comprised in a given interval [wₘ, w_{M}] of positive integers, which performs the following operations:

(a) choice of a positive integer N, N being the produce of the first k prime numbers, with maximum k for the existence of two positive integers εₘ and ε_{M} such that εₘ is the upper rounded number of wₘ/η, and ε_{M} is the lower rounded number of (w_{M}−wₘ)/η,

calculation of II=ε_{M}.η and ρ=εₘ.η,

generation of two positive integers a and c belonging to the multiplicative group Z*_{II} of integers modulo II, with c co-prime with II,

Calculation of q=c+p

(b) test of primality of q,

(c) in the case where primality is verified, the arithmetic processor stores q,

(d) in the contrary case:

c is updated by the calculation of a.c mod II,

the arithmetic processor reiterates the preceding operations starting from (b) with q=c+p.

The portable electronic device is advantageously constituted by a smart card with a microprocessor.

Other details and advantages of the invention will become clearly apparent on reading the description made by way of non-limiting example and with reference to the accompanying drawings.

FIG. 1 shows the set I of integers comprised within an interval [wₘ, w_{M}], the set III of integers of this interval being mutually prime, and finally the set IP of prime numbers of this interval,

FIG. 2 shows the flow chart of the method according to the invention,

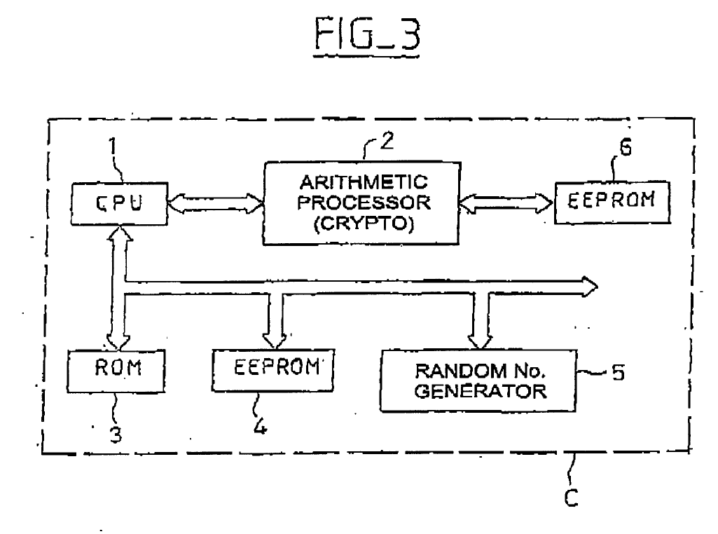

FIG. 3 shows a block diagram of a portable electronic device such as a smart card implementing the method according to the invention.

The purpose of the invention thus consists in a first time of determining II such that the set III of the integers prime with II shown in FIG. 1 is the closest possible to the subset IP of prime numbers of the interval.

According to the invention, the method shown in FIG. 2 is initialized in the following manner (step I):

To generate a prime number q such that q ε[wₘ, w_{M}],

a number η is chosen of the same form as II (η is the product of the first k′ prime numbers) where k′ is maximum and such that two positive integers εₘ and ε_{M} exist such that εₘ is the upper round number of wₘ/η, which is denoted □wₘ/η□, and ε_{M} is the lower round number of (w_{M}−wₘ)/η and is denoted by □(w_{M}−wₘ)/η□.

II is then obtained by setting n=ε_{M}.η; likewise ρ is set=εₘ.η.

It is noted that II is close to, but less than, w_{M}−wₘ and that ρ is close to, but greater than, wₘ.

It is now necessary to determine the updating of the candidates such that the new candidates always belong to III.

The ring Z_{II} of integers modulo II and the multiplicative group Z*_{II} of Z_{II} are considered; it is noted that the set (ρ+Z*_{II}) is included in, and approximately identical to, III, that is, to the set of candidates.

Two positive integers a and c belonging to this multiplicative group Z*_{II} are then generated, with c co-prime with II (that is, gcd (c, II)=1), and the candidate q=c+p is considered (step I). To generate c, an algorithm for the generation of co-prime numbers is used such as exists in the literature.

Since p is close to wₘ and c<II, it is automatically verified that wₘ<q<wM.

Furthermore, gcd (q, II)=gcd (c+p, II)=gcd (c, II)=1. It is thus verified that q effectively belongs to III.

When this initialization phase has ended, the primality of the candidate q is tested (step II). If it is verified, q is stored; if not:

c is updated by calculating a.c mod II and the new candidate q=c+p is calculated (step III).

The new candidate belongs to the set III: in fact, because of the properties of multiplicative groups, with a and c belonging to Z*_{II}; the product a.c also belongs to this group Z*_{II} as well as a.c mod II.

The public key cryptography protocols are often implemented on smart cards with microprocessor. For example, in the RSA protocol, the keys are generated starting from chosen numbers randomly chosen by the microprocessor card for executing the protocol. For this purpose, the microprocessor card possesses a random number generator, capable of providing an integer of the desired size.

Thus the block diagram of a microprocessor card able to implement the method according to the invention is shown in FIG. 3.

The card C comprises a central processing unit 1, program memories 3 and 4, and a working memory (not shown), associated with the unit 1. The card likewise comprises an arithmetic processor 2 capable of performing modular calculations, and a secure memory 6 (not accessible from the exterior), in which will be stored the candidate q whose primality will have been verified. The card likewise possesses a random integer generator 5.

For implementing the method, in particular on a microprocessor card as described, it is desirable to increase the processing speed for the method (operations effected by the arithmetic processor 2) and to release space in the working memory.

For this purpose, choosing a=2 and excluding 2 from the number II (II=3.5.7. . . . ), modular calculations are avoided. In fact, the update of c becomes 2c mod II. Now as c is an element of Z*_{II}, 2c mod II=2c, or 2c−II.

But the new candidates q can then be even. If this is the case, a number is then added to the new candidate such that the new candidate becomes odd, while still belonging to the set III. Thus setting:

II=(ε_{M}−1).η

q=c+p,

if q is even then q becomes q+η.

According to another alternative, II can be kept as initially defined, and a particular value of a can be chosen such that a is co-prime with II. For example, a=2¹⁶+1 can be chosen.

The method according to the invention has been implemented on a platform of smart card SLE66CX160S (Infineon) comprising an 8-bit central processing unit and a 1100-bit arithmetic cryptoprocessor. By choosing for η, II and ρ the following values:

η=b16bd1e084af628fe5089e6dabd16b5b80f60681d6a092fcb

1e86d82876ed71921000bcfdd063fb90f81df07a021af23c735d52

e63bd1cb59c93cbb398afd16,

II=1729.η,

ρ=4180.η,

a prime number of 512 bits is obtained with a=2 in less than 4 seconds. A prime number of 1024 bits is consequently obtained in less than 8 seconds on average.

1. Method of generation of an electronic key starting from a prime number q comprised in a given interval [wₘ, w_{M}] of positive integers, wherein the prime number q is obtained by performing the following operations:
(a) choice of a positive integer η, η being the product of the first k prime numbers, with k maximum for the existence of two positive integers εₘ and ε_{M} such that εₘ is the upper round number of wₘ/η, and ε_{M} is the lower round number of (w_{M}−wₘ)/η,
calculation of II=ε_{M}.η and ρ=εₘ.η,
generation of two positive integers a and c belonging to the multiplicative group Z*_{II} of integers modulo II, with c prime with II,
Calculation of q=c+ρ,
(b) test of primality of q,
(c) in the case in which primality is verified, q is stored,
(d) in the contrary case:
c is updated by calculating a.c mod II,
the preceding operations are reiterated starting from (b) with the new value q=c+p.

2. Method according to the foregoing claim, wherein a=2 and II=(ε_{M}−1).η

3. Method according to claim 1, wherein a=2¹⁶+1.

4. Method of generation of RSA, El Gamal, Schnorr, or Fiat Shamir cryptographic keys, wherein the process according to any one of the foregoing claims is implemented.

5. Portable electronic device comprising an arithmetic processor and an associated program memory, capable of effecting modular calculations, wherein it comprises a primality verification program for a positive integer q comprised in a given interval [wₘ, w_{M}] of positive integers and which performs the following operations:
(a) choice of a positive integer η, η being the product of the first k prime numbers, with k maximum for the existence of two positive integers εₘ and ε_{M} such that εₘ is the upper rounded number of wm/η and ε_{M} is the lower rounded number of (w_{M}−wₘ0)/η,
calculation of II=ε_{M.}η and ρ=εₘ.η,
generation of two positive integers a and c belonging to the multiplicative group Z*_{II} of integers modulo II, with c co-prime with II,
calculation of q=c+p
(b) test of the primality of q,
(c) in the case in which primality is verified, the arithmetic processor stores q,
(d) in the contrary case:
updating c by the calculation of a.c mod II,
the arithmetic processor reiterates the foregoing operations starting from (b) with q=c+p.

6. Portable electronic device according to claim 5, wherein it is constituted by a smart card with microprocessor.
